(19) United States
(12) Patent Application Publication
(10) Pub. No.: US 2022/0288541 A1
(43) Pub. Date: Sep. 15, 2022

(54) MULTI ADDITIVE CHANNEL HEAD

(71) Applicant: Drop Water Corporation, Menlo Park, CA (US)

(72) Inventor: Scott Paul EDWARDS, Redwood City, CA (US)

(21) Appl. No.: 17/200,626

(22) Filed: Mar. 12, 2021

(51) Int. Cl. B01F 3/08; B01F 3/04; B01F 5/04; B01F 15/02

(52) U.S. Cl. CPC B01F 3/088; B01F 3/0865; B01F 3/0446; B01F 3/04815; B01F 5/0478; B01F 5/0486; B01F 15/026; B01F 2003/049; B01F 2215/0022; B01F 2215/0077

(57) ABSTRACT

A device for automatically and selectively dispensing multiple additives into a base liquid is disclosed, where each additive is dispensed by a control mechanism that effectively shuts off and is self-cleaning. In one embodiment, each additive is provided through a channel comprising a tube, a check disk, and a fulcrum. When the pressure of a particular additive increases above a threshold, a flexure is created in the check disk, which causes an opening that allows the additive to enter a main channel where it is mixed with a base liquid. When the pressure of the liquid additive is decreased below the threshold, the check disk reverts to its original form and the additive is no longer dispensed into the base liquid. Thereafter, the base liquid cleanses the mechanism.

### TECHNICAL FIELD

A device for automatically and selectively dispensing multiple additives into a base liquid is disclosed, where each additive is dispensed by a control mechanism that effectively shuts off and is self-cleaning.

### BACKGROUND OF THE INVENTION

There are numerous applications in different fields of prior art requiring liquid additives to be selectively mixed into a base liquid. Examples include beverage dispensing machines, manufacturing facilities, chemical factories, laboratories, paint stores, and commercial kitchens.

The prior art includes automated dispensing devices for performing this function, such as prior art additive dispenser 100 depicted in FIGS. 1A, IB, and IC.

With reference to FIG. 1A, additive dispenser 100 comprises main channel 104 and valves 101, such as exemplary valves 101-1 and 101-2. Base liquid 103, such as water, flows through main channel 104. Additives are selectively added using valves 101-1 and 101-2.

In FIG. 1B, it is desired to dispense additive 102-2 into base liquid 103. The pressure of additive 102-2 is increased, and additive 102-2 traverses through valve 101-2, either by permeating through a membrane, pushing through a seal, or other mechanism.

FIG. 1C depicts additive dispenser 100 at a later point in time after additive 102-2 has been added to water 103. At this point in time, valve 101-2 is intended to be shut off. However, due to the design of valves 101-2, there is an amount of additive 102-2 remaining at the bottom of valve 101-2 following the dispensing process of FIG. 1B. This amount may wick into base liquid 103 after the events of FIG. 1B at a time when it is not desired, which results in the solution in main channel 104 containing additive 102-2 when it was not intended, resulting in unwanted contamination In addition, over time, solid deposits 104 may form at the bottom of valve 101-2 as particulates in additive 102-2 crystallize, and it will be necessarily to periodically clean valves 101-2. This increases the maintenance time and cost for any system containing additive dispenser 100.

What is needed is an improved dispensing device that dispenses additives into a base liquid with a more effective shut-off mechanism than in the prior art so that after shut-off there is reduced contamination of that additive. What is further needed is a dispensing device that is self-cleaning so that maintenance of the system is significantly lower compared to prior art systems.

### SUMMARY OF THE INVENTION

A device for automatically and selectively dispensing multiple additives into a base liquid is disclosed, where each additive is dispensed by a control mechanism that effectively shuts off and is self-cleaning. In one embodiment, each additive is provided through a channel comprising a tube, a check disk, and a fulcrum. When the pressure of a particular additive increases above a threshold, a flexure is created in the check disk, which causes an opening that allows the additive to enter a main channel where it is mixed with a base liquid. When the pressure of the liquid additive is decreased below the threshold, the check disk reverts to its original form and the additive is no longer dispensed into the base liquid. Thereafter, the base liquid cleanses the mechanism.

### BRIEF DESCRIPTION OF THE DRAWINGS

FIGS. 1A, 1B, and 1C depict a prior art additive dispenser in a sequence of events in which an additive is dispensed into a base liquid.

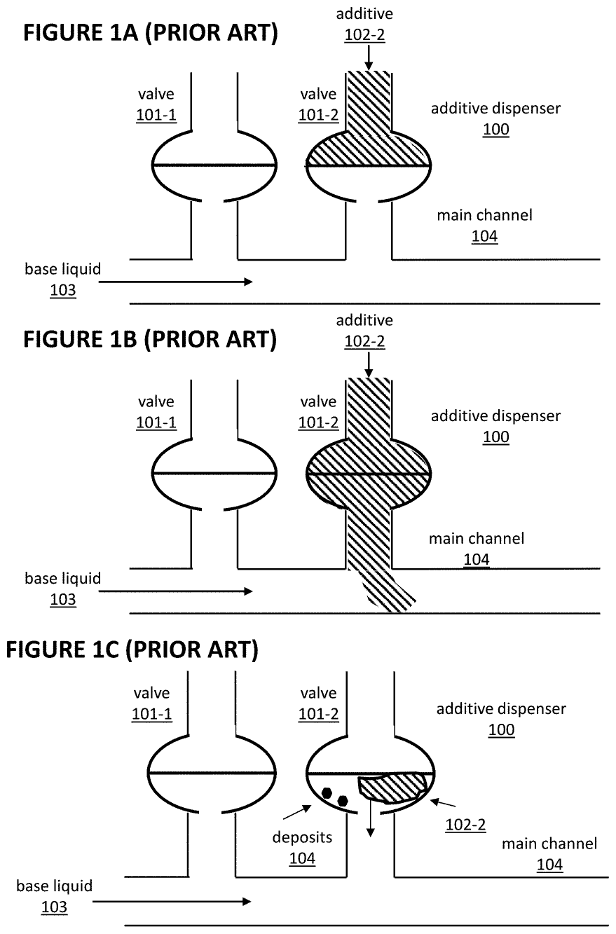

FIG. 2 depicts a top view of a multi additive channel head.

FIG. 3 depicts an exploded view of the multi additive channel head of FIG. 2.

FIG. 4 depicts additive flow into the multi additive channel head of FIG. 2.

FIG. 5 depicts a bottom view of the multi-additive channel head of FIG. 2.

FIGS. 6A, 6B, and 6C depict a multi-additive channel head in a sequence of events in which an additive is dispensed into a base liquid.

FIG. 7 depicts a top view of a top piece of a multi additive channel head.

FIG. 8 depicts a bottom view of the top piece of FIG. 7.

### DETAILED DESCRIPTION OF THE PREFERRED EMBODIMENTS

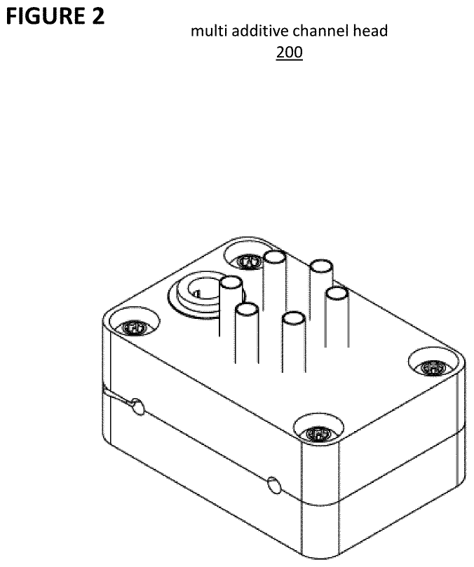

FIG. 2 depicts a top view of multi additive channel head 200, which is an improvement over prior art dispensing devices such as additive dispenser 100.

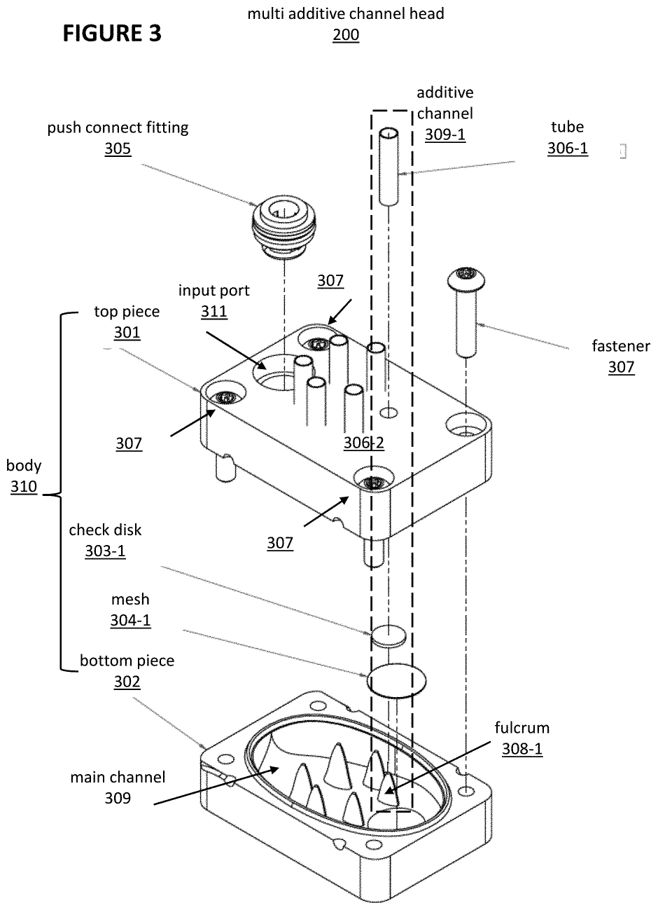

FIG. 3 depicts an exploded view of multi additive channel head 200. Multi additive channel head 200 comprises top piece 301, bottom piece 302, input port 311, push connect fitting 305, and fasteners 307. Fasteners 307 hold top piece 301 against bottom piece 302 to form body 310. Body 310 contains main channel 309 formed by top piece 301 and bottom piece 301. Push connect fitting 305 is inserted into input port 311 and provides a sealed connection into main channel 309 through which a base liquid can be provided.

Multi additive channel head 200 further comprises a plurality of additive channels, where each additive channel is used to selectively and automatically add an additive into a liquid base in main channel 309. Here, exemplary additive channel 309-1 is highlighted. This particular example of multi additive channel head 200 contains six different additive channels, including additive channel 309-1. One of ordinary skill in the art will appreciate that multi additive channel head 200 can be built with any number of additive channels.

Additive channel 309-1 comprises tube 306-1, check disk 303-1, mesh 304-1, and fulcrum 308-1. Each of the other additive channels comprises the same components. A first end of tube 306-1 is located on the outside of body 310, and a second end of tube 306-1 is in main channel 309 inside of body 310 and abuts check disk 303-1, mesh 304-1, and fulcrum 308-1. Check disk 303-1 and mesh 304-1 are held in place between tube 306-1 and fulcrum 308-1. Check disk 303-1 controls the flow of an additive into main channel 309. Mesh 304-1 acts as a filter on the additive flow.

Body 310 can be constructed from polypropylene or other known materials. Tube 306-1 can be constructed from stainless steel, plastic, or other known materials. Check disk 303-3 can be constructed from rubber or other known flexible materials. Mesh 304-1 can be constructed from steel or other known materials.

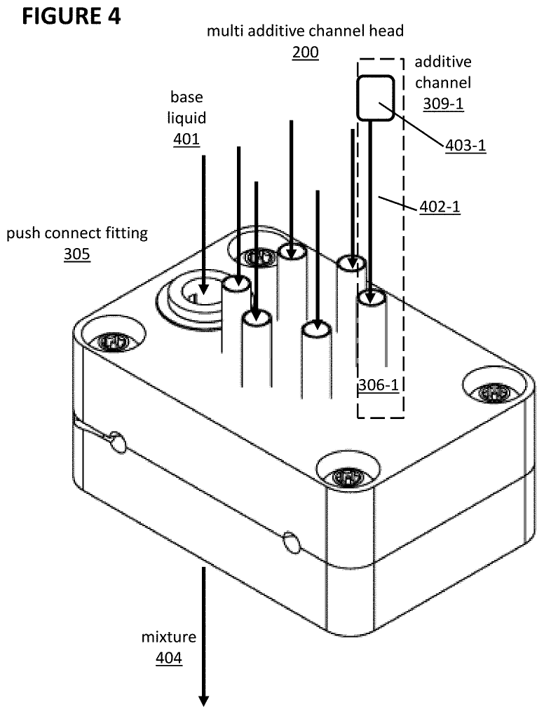

FIG. 4 depicts multi additive channel head 200 in non-exploded form. Each additive channel receives a liquid additive supply. Here, tube 306-1 in additive channel 309-1 receives additive 402-1. Pressure device 403-1 is located upstream from tube 306-1 and is able to increase the pressure of additive 402-1. For example, pressure device 403-1 can be a pump.

A base liquid 401 is provided into push connect fitting 305 through, for example, a tube (not shown), where it enters main channel 309.

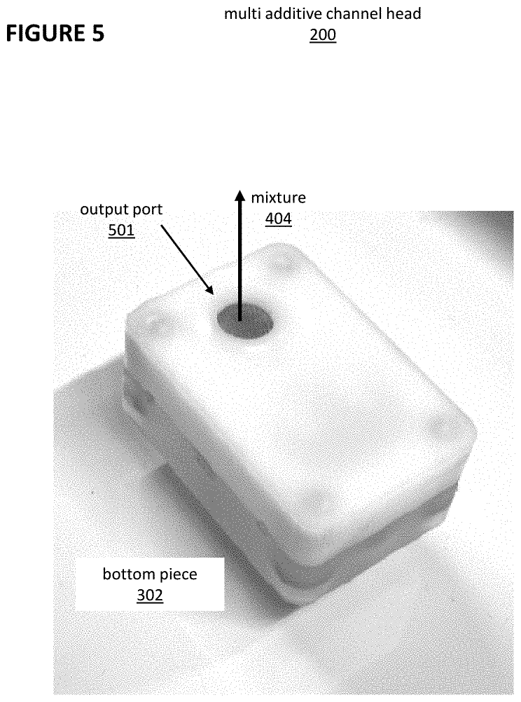

With reference to FIGS. 4 and 5, bottom piece 302 comprises output port 501 through which mixture 404 emerges, where mixture 404 is a mixture of base liquid 401 and one or more additives 402 that were dispensed into base liquid 401.

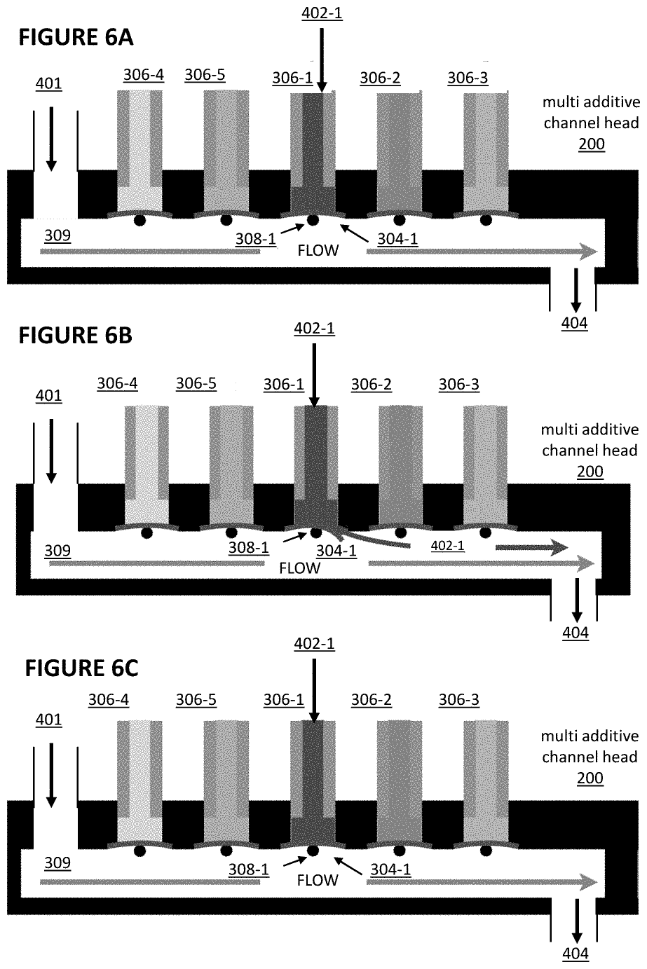

FIGS. 6A, 6B, and 6C depict a cross-sectional view of multi-additive channel head 200. For ease of illustration, the various additive channels have been spread out so each can be viewed in the cross section.

In FIG. 6A, base liquid 401 flows through main channel 309. No additives are being added to base liquid 401 at this time. Mixture 404 emerges from output port 501 but at this time consists only of base liquid 401.

In FIG. 6B, additive 402-1 is being added. The pressure of additive 402-1 is increased, for example, by pressure device 403-1 in FIG. 4. The increased pressure causes a flexure in check disk 303-1 along fulcrum 308-1, such that an opening is created that enables additive 402-1 to flow into main channel 309 and mix with base liquid 401. Mixture 404 emerges from output port 501 and comprises base liquid 401 mixed with the dispensed amount of additive 402-1. The physical qualities of check disk 303-1 are such that the pressure required to cause a flexure are a knowable quantity. For example, a flexure in check disk 303-1 might occur at 10 psi. The flexure point of check disk 303-1 is a threshold that can be used in controlling the additive process. Increasing the pressure of an additive above the threshold will result in additive being dispensed, and decreasing the pressure below the threshold will result in the additive no longer being dispensed (i.e., shut-off).

In FIG. 6C, additive 402-1 is no longer being added. The pressure of additive 402-1 has been decreased below the threshold, for example, but turning down or turning off pressure device 403-1. Check disk 303-1 then reverts to its original form and creates an impermeable barrier that prevents additive 402-1 from entering main channel 309. Base liquid 401 engages in a cleaning action of the bottom of check disk 303-1 and mesh 304-1 (not shown). Unlike in the prior art, there is no subsequent wicking of additive 402-1 into main channel 309 after shut-off. This cleaning action reduces or eliminates any possible buildup of solid particles from additive 402-1 on the bottom of check disk 303-1. Almost immediately after shut-off, mixture 404 emerging from output port 501 will consist only of base liquid 401.

In embodiments where multi additive channel head 200 is used in a beverage dispenser, then base liquid 401 might be water, coffee, tea, or another base, and the additives might include liquid flavors or other desired additives. The additives also might include carbon dioxide gas to create a carbonated beverage. Other base liquids and additives can be used in other applications of multi additive channel head 200.

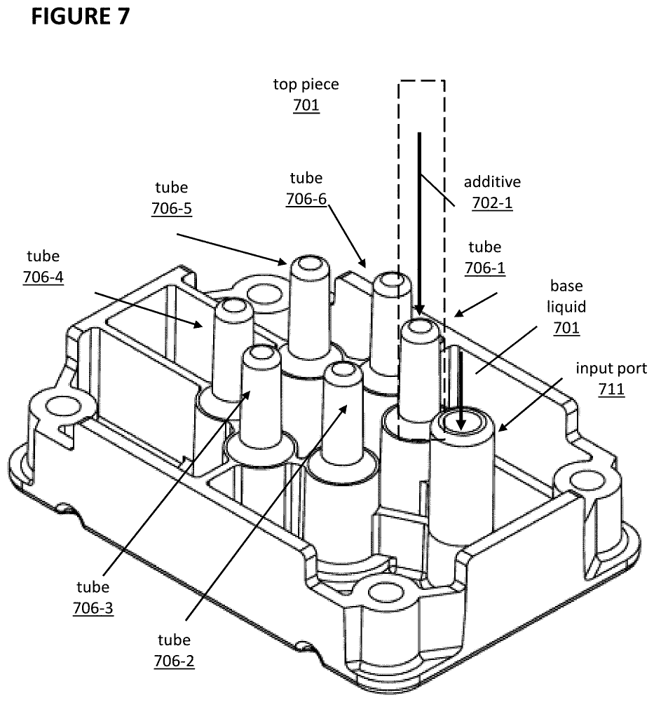

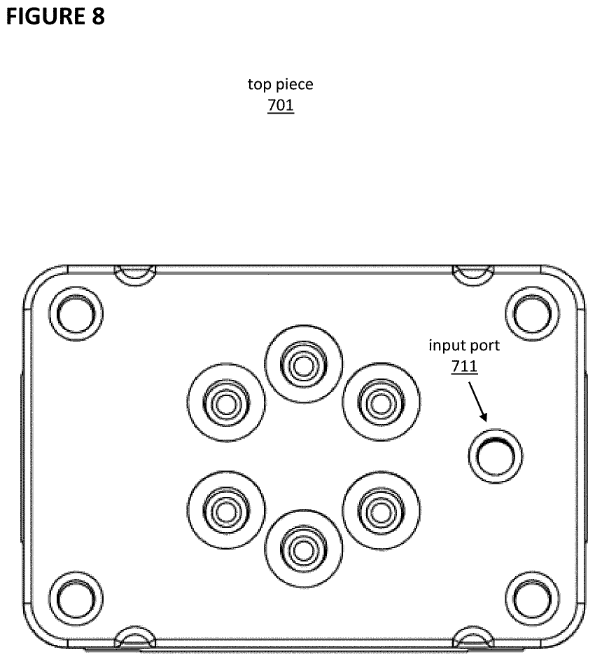

FIGS. 7 and 8 depict another embodiment of top piece 701, which can be used in multi additive channel head 200. FIG. 7 depicts a view of one side of top piece 701 from an upward view. Top piece 701 comprises tubes 706-1, 706-2, 706-3, 706-4, 706-5, and 706-6 and input port 711. Exemplary additive channel 709-1 is depicted and comprises tube 706-1 into which additive 702-1 is selectively injected. Base liquid 701 is selectively injected into input port 711.

FIG. 8 depicts a view of an opposite side of top piece 701 from an upward view. The opposite side of input port 711 is depicted. Top piece 701 functions in the same manner described above for top piece 301.

In one embodiment, one or more of the additives can be a cleaning or disinfecting agent, such as a chlorine solution. For example, additive 402-1 or 702-1 can be a chlorine solution that is periodically injected into multi additive channel head 200 to thoroughly clean and disinfect it. Optionally, after this cleaning and disinfecting process, base liquid 401 or 701 can be used to thoroughly rinse multi-additive channel head so that the chlorine solution is not introduced into any beverages.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims.

What is claimed is:

1. A device for dispensing one or more additives into a base liquid, comprising:
a body comprising a main channel, an input port for receiving a base liquid into the channel, one or more additive channels, and an output port for outputting a mixture, each of the one or more additive channels comprising:
a tube for providing an additive;
a check disk; and
a fulcrum;
wherein the additive enters the main channel into the mixture when a pressure of the additive exceeds a flexure threshold of the check disk.

2. The device of claim 1, wherein an additive in at least one of the one or more additive channels is a liquid.

3. The device of claim 1, wherein an additive in at least one of the one or more additive channels is a cleaning and disinfecting solution.

4. The device of claim 1, wherein an additive in at least one of the one or more additive channels is a gas.

5. The device of claim 1, further comprising a push connect fitting engaged with the input port and the base liquid is provided through the push connect fitting.

6. The device of claim 1, wherein the main body comprises a top piece and a bottom piece connected with one or more fasteners.

7. The device of claim 1, wherein each of the one or more additive channels further comprises a mesh, wherein the mesh is located between the check disk and the fulcrum.

8. The device of claim 1, wherein the body is constructed from polypropylene.

9. The device of claim 1, wherein the tube in each of the one or more additive channels is constructed from stainless steel.

10. The device of claim 1, wherein the check in each of the one or more additive channels is constructed from rubber.

11. A device for dispensing one or more additives into water, comprising:
a body comprising a main channel, an input port for receiving water into the main channel, one or more additive channels, and an output port for outputting a mixture of water and one or more additives, each of the one or more additive channels comprising:
a tube for providing an additive;
a check disk; and
a fulcrum;
wherein the additive enters the main channel into the mixture when a pressure of the additive exceeds a flexure threshold of the check disk.

12. The device of claim 11, wherein an additive in at least one of the one or more additive channels is a liquid flavor additive.

13. The device of claim 12, wherein an additive in at least one of the one or more additive channels is carbon dioxide gas.

14. The device of claim 11, wherein an additive in at least one of the one or more additive channels is a cleaning and disinfecting solution.

15. The device of claim 11, wherein an additive in at least one of the one or more additive channels is carbon dioxide gas.

16. The device of claim 11, further comprising a push connect fitting engaged with the input port and the water is provided through the push connect fitting.

17. The device of claim 11, wherein the main body comprises a top piece and a bottom piece connected with one or more fasteners.

18. The device of claim 17, wherein the fulcrum in each of the one or more additive channels is molded into the bottom piece.

19. The device of claim 11, wherein each of the one or more additive channels further comprises a mesh, wherein the mesh is located between the check disk and the fulcrum.

20. The device of claim 11, wherein the body is constructed from polypropylene.

21. The device of claim 11, wherein the tube in each of the one or more additive channels is constructed from stainless steel.

22. The device of claim 11, wherein the check disk in each of the one or more additive channels is constructed from rubber.
